(19) United States
(12) Patent Application Publication
(10) Pub. No.: US 2002/0054104 A1
(43) Pub. Date: May 9, 2002

(54) ANTICIPATORY PROCESSING FOR A GRAPHICAL USER INTERFACE

(76) Inventors: STEPHEN C. BERCZIK, NEW MILFORD, NJ (US); SCOTT L. LENNARTZ, EATONTOWN, NJ (US)

Correspondence Address: GIBBONS DEL DEO DOLAN, GRIFFINGER & VECCHIONE, ONE RIVERFRONT PLAZA, NEWARK, NJ, 071025497

(21) Appl. No.: 09/185,050

(22) Filed: Nov. 3, 1998

(51) Int. Cl. G06F 3/00

(52) U.S. Cl. 345/764

(57) ABSTRACT

The invention designates an object, command or series of commands for anticipatory processing. If the function associated with the designated object, command or series of commands requires resources, the resources are allocated to the function implemented by the anticipated command, if available. While waiting for the user to commit to the designated object, command or series of commands, the system also collects the data necessary to perform the anticipated function. When the user commits to the designated object, command or series of commands, the commands are executed without waiting for the system to acquire the necessary resources.

### FIELD OF INVENTION

This invention generally relates to improvements in computer systems and more particularly to apparatus and method for improving the response time of a computer using a graphical user interface.

### BACKGROUND

Computer systems have obtained widespread use in modem society. One of the most important aspects of a computer system is the interface between the human user and the computer. Many modem computer systems operate with a graphical user interface (GUI), where the machine communicates with the user by displaying objects as graphics, including text and pictures, on a display screen, and the user communicates with the machine by typing textual commands and by manipulating the display with a pointing device. The graphics displayed on a GUI screen typically represent underlying objects, such as applications, functions within applications, or data for use by applications and functions.

With a GUI, the user controls a pointer with a hand-manipulated selection device such as a mouse, trackball, or rotating wheel. The pointer control device provides signals indicative of the pointer's X-Y position on the display screen. The coordinates of objects on the display screen are also known, and the user can select an object by placing the pointer on the same coordinates as the object and depressing and releasing a selection switch on the pointer control device.

A variety of computer applications use GUI's to communicate with the user. In a computer system controlling some other device or system, the GUI typically displays a control panel for the device. The panel includes objects representing buttons, switches, gauges and sliders. The user treats these objects as physical devices and expects the controlled system to behave accordingly. For instance, where a user throws a switch on the GUI intending to activate the controlled system, the user expects the activation to occur as if the GUI switch were a physical switch.

Using a GUI, especially as a control interface, presents serious limitations, however. The underlying apparatus does not respond to signals from the GUI until the user has committed to the selection of the particular object. Once the user commits to a selection, the GUI signals the object with responsibility for implementing the desired function. Sometimes an object is selected in a single selection maneuver, but many times the user commits to a particular selection with a series of maneuvers, such as clicking on objects in a series of pop down menus. The series of selections are composed into a command string which is executed when the user makes a last selection. The computer then acquires the resources to perform the function, including accessing any controlled devices.

It is a disadvantage of a present day computer implementing a GUI that the user must wait until the command or commands are executed and resources allocated before the desired function is accomplished. A user perceives the waiting time as a slow computer response, which leads to inattention and frustration. There is a need, therefore, to improve the response time of a computer implementing a GUI, especially where the objects on the GUI activate control over some other system or device.

### SUMMARY OF THE INVENTION

The invention improves the responsiveness of a computer system providing a graphical user interface (GUI). In one embodiment, a computer implementing the method of the invention anticipates the selection of objects on a GUI, and signals the underlying apparatus before the user completes his selection. The system determines whether the resources necessary to perform the anticipated function are available, and, if so, schedules and allocates the resources. While waiting for the user to commit to the anticipated selection, the system also collects whatever data is necessary to perform the anticipated function. When the user commits to the anticipated selection, only the very last parts of the command string need to be processed before the intended results occur.

The method of the invention determines the most likely object for selection by monitoring the GUI for inquiries to the user. When the invention detects an inquiry event, a look-up table is accessed. The table contains the possible subsequent event-sequences (scenarios of user responses to the inquiry). By application of a predetermined selection criteria, the invention designates one or more event-sequences as requiring anticipatory processing. The invention requests the system to allocate the required resources to perform the anticipated tasks and signals the underlying objects with responsibility for performing the necessary functions. When the final user selection is signaled, as by release of the mouse button, the resources are committed, the tasks are performed and the GUI causes the results to be presented to the user.

In another embodiment, the invention monitors a predetermined area around objects of interest displayed on the GUI screen. When the selection device, preferably a pointer manipulated by a mouse, enters the predetermined area for a given object, the invention monitors the pointer movement. If the pointer movement slows or stops in that area, selection of the object is anticipated, and the invention requests the system to allocate the resources required by the object. When the user commits to the selection by pressing and releasing the mouse button, the function is accomplished without waiting for resource allocation.

### BRIEF DESCRIPTION OF THE DRAWINGS

A more complete understanding of the present invention may be obtained from consideration of the following description in conjunction with the drawings in which:

FIG. 1 shows the architecture of a prior art GUI;

FIG. 2 shows a typical GUI display;

FIG. 3 shows an exemplary embodiment of a computer-based system;

FIG. 4A and 4B show apparatus for one embodiment of the invention;

FIG. 5A and 5B show apparatus for another embodiment of the invention;

FIG. 6 shows processing according to one aspect of this invention;

FIG. 7 shows one method according to this invention;

FIG. 8 shows an exemplary graphical user interface display;

FIG. 9 shows another exemplary system operating according to the invention; and,

FIG. 10 shows a flow chart illustrating one feature of the invention.

### DETAILED DESCRIPTION

Apparatus and method according to the invention perform anticipatory processing in a system implementing a graphical user interface (GUI). In a preferred embodiment, the GUI is implemented in a computer controlling some system or device. To better understand the invention, the architecture of a prior art GUI is first described, including the operation of a typical operating system and windowing system. Thereafter, exemplary hardware implementing a UNIX® operating system and using a mouse as a selection device, for operating the invention is provided. It should be clear, however, that the invention can be applied under other operating systems, such as Windows 95®, Windows 98® or Windows NT®. Next, two architectures for implementing anticipatory processing for a GUI, according to the method of the invention, are discussed. Finally, specific examples illustrating the invention are presented.

When implementing a prior art GUI, it is known to use UNIX® as a computer operating system and XWindows® as the windowing system for providing an interface between the user and the GUI. XWindows is designed around a client/server architecture. This term denotes a cooperative data processing effort between certain computer programs, called servers, and other computer programs, called clients. XWindows is a user interface device server which handles among other things, the task of controlling the user interface devices. GUIs are clients, which are programs that need to receive input from a keyboard or mouse and to transmit output to a screen display. XWindows provides data processing services to a GUI, since the GUI cannot perform operations directly on the display.

Through XWindows, a GUI is able to interact with the user interface devices, including a keyboard, a display and a mouse. XWindows and the GUI communicate with each other by exchanging messages. XWindows uses what is called an event model. An event is any input to the GUI, including operator actions, sensor input or any other command to the GUI. The GUI informs XWindows of the events of interest to the GUI, such as information entered via a keyboard or the clicking of a mouse (pointing device) in a predetermined area, and then waits for any other system responses to occur. Upon such occurrence, XWindows notifies the GUI, and the GUI presents the results.

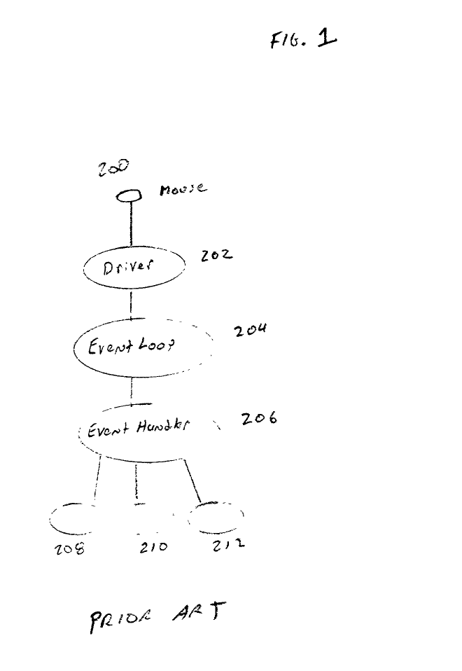

A high-level diagram of an exemplary architecture for implementing a GUI is shown in FIG. 1. A selection device exemplified by mouse 200 provides an input signal to Driver 202 which converts the signals from the mouse 200 to computer accessible signals. Event Loop 204 monitors for signals representing events of interest to the GUI, including computer generated events and user generated events. When Event Loop 204 detects an event of interest, it routes the event to EventHandler 206. Depending on the function required to address the event, EventHandler 206 sends the event to one of the objects 208, 210 and 212 which has responsibility to perform the function. The selected object accomplishes the desired function.

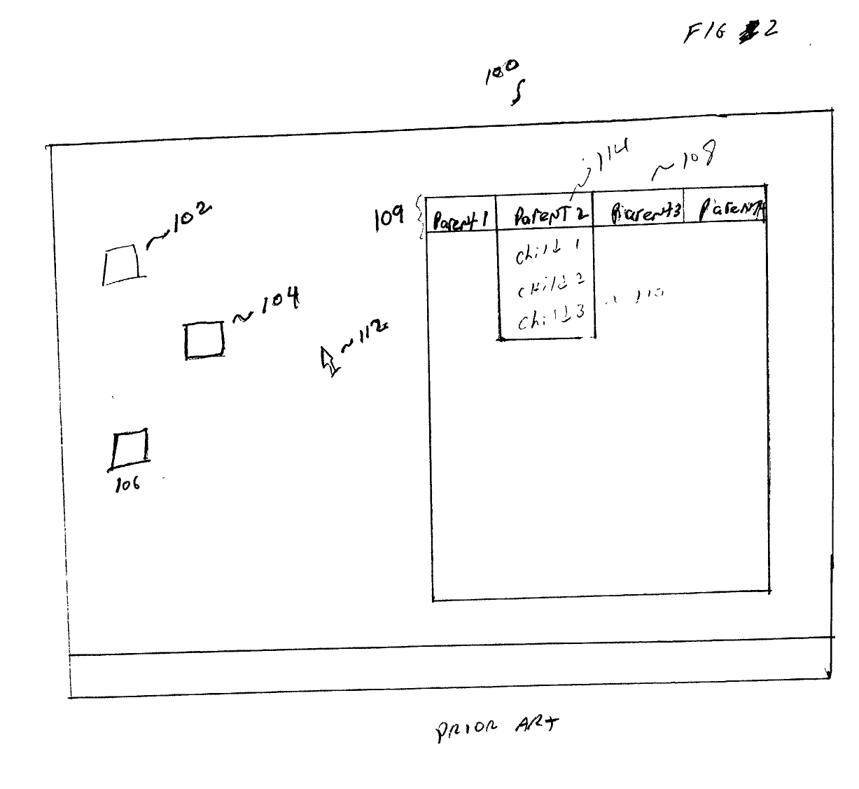

FIG. 2 shows a display 100 displaying objects 102 and 104, a pointer 112, and an opened window 108 representing an object selected by pointer 112, display 100 being implemented in a window environment according to the architecture of FIG. 1. Window 108 displays a menu bar 109 showing objects Parent 1, Parent 2, Parent 3 and Parent 4. Parent 2 has been selected and displays a submenu 110 displaying objects Child 1, Child 2 and Child 3. In a system implementing a prior art GUI, a selected object and its required resources will not respond to signals from the GUI until the user has committed to a selection. Thus, the underlying apparatus—the entity (software or hardware) responsible for delegating resources will not respond until the user selects either Child 1, Child 2 or Child 3.

The method of the invention reduces the time between the user's commitment to a particular object represented on a GUI display and the response of the underlying software or hardware. The invention designates an object or objects as requiring anticipatory processing and prepares for the user's selection of the object. The computer system then seeks to allocate the resources necessary to perform the anticipated selection. If the resources are available, the system allocates the resources to the anticipated selection and then awaits the confirming event.

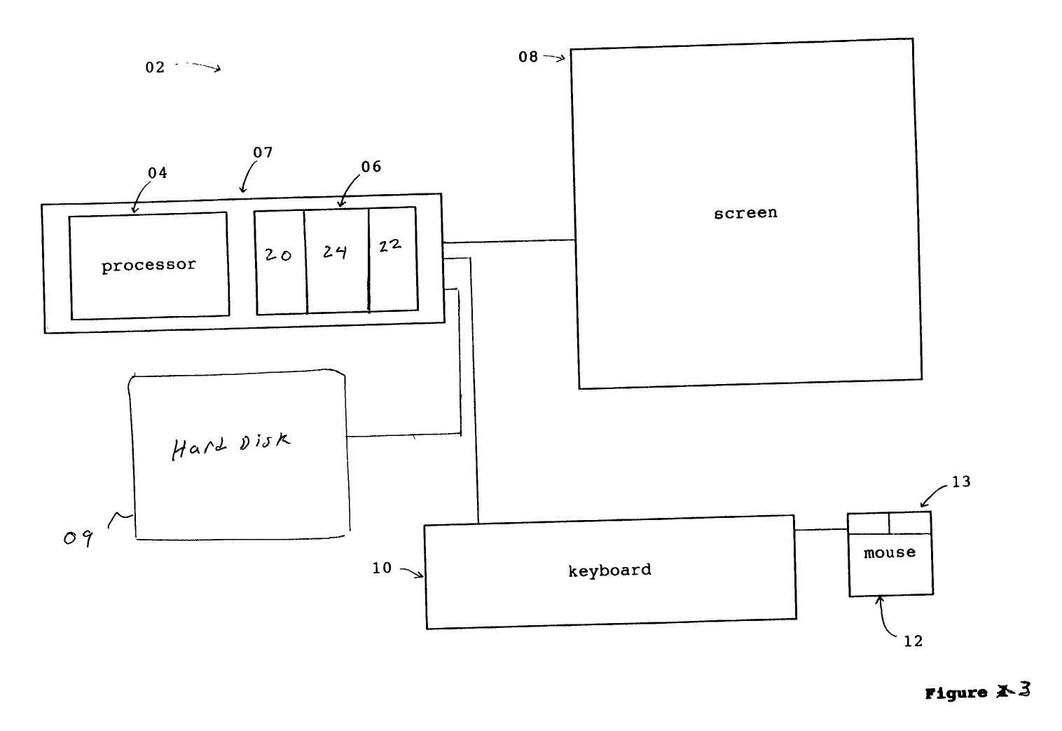

FIG. 3 illustrates an exemplary embodiment of a computer-based system 02 according to the invention. The system 02 comprises a processing unit 07, a display screen terminal 08, input devices, e.g., a keyboard 10, and storage devices, such as a hard disk 09. The processing unit 07 includes a processor 04 and a memory 06. The memory 06 includes areas 20, 22 and 24 for storing, among other things, instructions for processor 04. A selection device 12 includes switches 13 having a positive on and a positive off position for generating signals to the system 02. The screen 08, keyboard 10 and selection device 12 are collectively known as the user interface devices. In the preferred embodiment of the invention, the system 02 utilizes UNIX® as the computer operating system and XWindows® as the windowing system for providing an interface between the user and a GUI. UNIX and XWindows can be found resident in area 20 and 22, respectively, in the memory 06.

When implemented as a set of instructions for a computer processor, the method of the invention can be found resident in area 24 in the memory 06 of the system 02. Such a software implementation may be written in the Tcl-Tk language and it preferably operates with the standard windowing shell provided with the Tcl-Tk package. Tcl is a simple scripting language (its name stands for “tool command language”) for controlling and extending applications. Tk is an XWindows toolkit which extends the core Tcl facilities with commands for building user interfaces having Motif “look and feel” in Tcl scripts instead of C code. Motif “look and feel” denotes the standard “look and feel” for XWindows as is known in the art and defined by Open Software Foundation®. Tcl and Tk are implemented as a library of C procedures so it can be used in many applications. Tcl-Tk, information and related products are available from The TCL/TK Consortium through its web site. Its URL is www.tclconsortium.org. Tcl and Tk are fully described by John K. Ousterhout in a 1994 publication entitled “Tcl and the Tk Toolkit” from Addison Wesley Publishing Company.

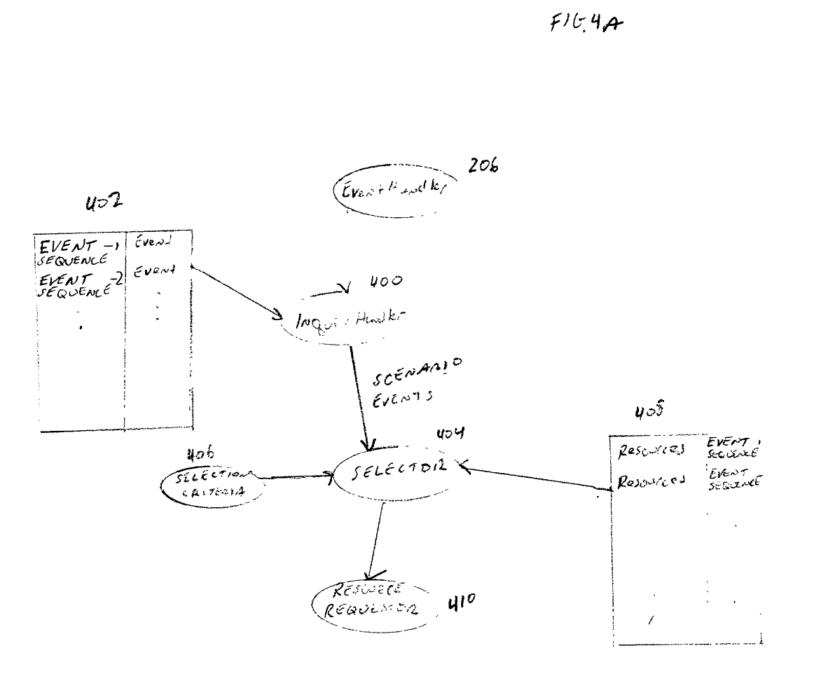

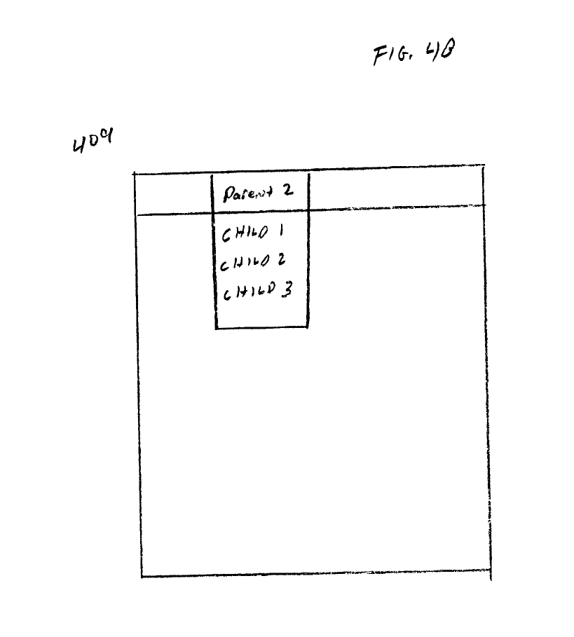

Operation of the feature of the invention for designating an anticipated selection (or selections) will now be described for two embodiments. In one embodiment, shown in FIG. 4A, the feature responds to non-user events to the GUI, such as a system inquiry. EventHandler 401 routes such non-user GUI events to an object InquiryHandler 400 which is operable to determine the possible user responses to the event. Such events include both textual inquiries, such as asking whether the user wishes to continue with a selection, and displayed lists of possible user selections, such as in menus and submenus.

Once EventHandler 401 signals InquiryHandler 400 of the inquiry event, InquiryHandler 400 associates the event with each possible scenario of user responses. These scenarios are the sets of possible subsequent event-sequences in response to the displayed inquiry. For instance, referring to FIG. 4B, there are three event-sequences associated with the displayed submenu 409: Parent 2 with Child 1, with Child 2 or with Child 3. In the presently described embodiment, InquiryHandler 400 makes this association by means of a look-up table 402, where the look-up table 402 associates the inquiry event with all sets of possible user responses (event-sequences). Thus, the Parent 2 event is associated in table 402 with the just described event-sequences.

A Selector 404 receives from InquiryHandler 400 the set or sets of event-sequences associated with the inquiry event of interest and applies a selection criteria 406 to determine which event-sequence or sequences should undergo anticipatory processing according to the resources required to perform the described functions. Typically one event-sequence will cancel the operation, requiring little or no resources. In a preferred embodiment, application of the selection criteria 406 eliminates cancellation as an anticipated event-sequence. If only one other event-sequence exists, then the alternative sequence is designated for anticipatory processing. Otherwise, Selector 404 applying selection criteria 406 determines whether any event-sequence will result in access to a controlled system or device and designates this sequence as requiring anticipatory processing. So, for instance, if Child 1 is a cancellation, Selector 404 determines whether Child 2 or 3 required access to a controlled system or device. If Child 2 requires access to a controlled device, Selector 404 selects the Child 2 event-sequence.

If at least two event-sequences exist and none require access to a controlled device, then Selector 404, after having made that determination, applies criteria 406, and determines whether any sequence requires networked or distributed devices or services (resources). If so, Selector 404, designates this sequence for anticipatory processing. Thus, if selection of Child 2 requires access to a networked printer, while selection of Child 1 or Child 3 will require standalone resources, Selector 404 will designate Child 2 for anticipatory processing.

If no event-sequence is selected based upon the priorities described above, Selector 404 determines whether any sequence requires access to non-networked devices or resources, such as printers, and designates such sequence for anticipatory processing. If two or more sequences satisfy any of the above criteria, Selector 404 determines whether any of the sequences require common resources, and, if so, selects for anticipatory processing the sequence which requires the most common resources. Otherwise, Selector 404 designates for anticipatory processing the event-sequence requiring the most resources.

In applying the described selection criteria for the exemplary embodiment, as illustrated is FIG. 4A, the data required to apply the selection criteria 406 is implemented with a look-up table 408. The table 408 associates an event-sequence to the resources required to perform the function each scenario implements. Consider where selection of Child 1 cancels an operation, selection of Child 2 prints a document on a networked printer, and selection of Child 3 establishes access to a dedicated modem, perhaps for faxing. The look-up table 408 associates the sequences of interest to the resources they require. Selector 404 by accessing the table 408 determines that selection of Child 1 requires little or no resources, selection of Child 2 requires distributed resources and selection of Child 3 requires stand alone resources. Applying the selection criteria 406 described above, Selector 404 chooses Child 2 for anticipatory processing.

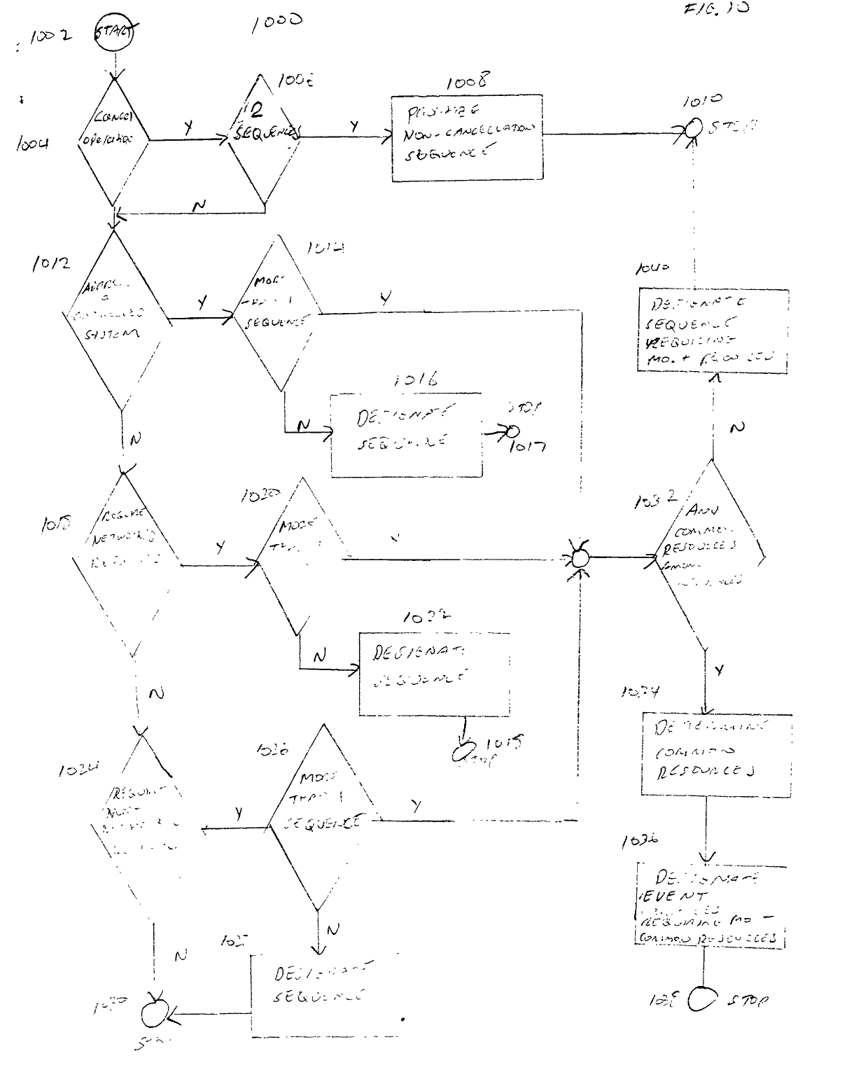

The operation of the just described objects 401, 400, 404, tables 402, 408 and selection criteria 406 is further explained with reference to the flow chart 1000 of FIG. 10. Process flow starts 1002 when an inquiry event of interest occurs. In a decision step 1004, the system determines whether any event-sequence cancels the pending operation. In many cases, only one other event sequence exists and this is determined in a decision step 1006. If only one other event-sequence exists, the system designates the function implemented by this sequence for anticipatory processing 1008. Otherwise process flow is sent to a decision step 1012 which determines whether any event-sequence addresses a controlled system or device.

If an event-sequence addresses a controlled system or device, a next decision step 1014 determines whether more than one event-sequence addresses a controlled system or device. When the step 1014 determines that only one event-sequence addresses a controlled system, a process step 1016 designates the function implemented by this event-sequence for anticipatory processing. If more than one event-sequence addresses a controlled system, process control is transferred to a decision step 1032, which process will be discussed hereafter.

If no controlled system is addressed, process passes to a decision step 1018 which determines if any event-sequence implements a function that requires access to networked resources, such as a networked printer. When such resources are required, a decision step 1020 determines whether more than one event-sequence satisfies the stated criteria. If only one event-sequence implements a function that requires access to networked resources, a process step 1022 designates the function implemented by that event-sequence for anticipatory processing. When more than one-sequence implements a function requiring access to networked resources, process control is transferred to a decision step 1032.

Still referring to the flowchart 1000, if no networked resources are implemented by any event-sequence, a decision step 1024 determines whether any event-sequence will implement a function requiring non-networked resources. If no event-sequence implements a function requiring non-networked resources, the process stops 1030 and the system awaits for an event of interest to occur. When the system determines that non-networked resources are required, a decision step 1026 determines whether more than one event-sequence implements a function having such a requirement. When only one event-sequence satisfies the criteria, a process step 1028 designates that event-sequence as anticipated. If more than one event-sequence satisfies the above criteria, process flow is transferred to a decision step 1032.

In each of the cases where more than one event-sequence satisfies a particular criteria, the decision step 1032 determines whether any of the event-sequences satisfying the criteria implement a function requiring common resources. In other words, the system decides if more than one event-sequence implements a function requiring, for example, a networked printer. If they do, a process step 1034 determines all resources common to all such event-sequences. A process step 1036 then designates the event-sequence which implements a function requiring access to the most resources which are common to the event sequences of interest as the anticipated event-sequence. In the case where none of the event-sequences implement functions having resources in common, a process step 1040 designates the event-sequence implementing the function requiring the most resources as the anticipated event-sequence. Once a designation occurs, the process stops 1010, 1038 and the system waits for another event of interest to occur.

Of course, the described embodiment can be configured in various ways and, depending on requirements, any given event-sequence may or may not be designated for anticipatory processing. For instance, a given sequence may be deemed so important that it is prioritized in any set of event-sequences. Some other sequence may implement little more than house keeping functions, and a user may wish to exclude this sequence from possible selection for anticipatory processing. Other selection criteria will be apparent to one of ordinary skill in the art depending upon specific requirements.

Now referring again to FIG. 4A, once Selector 404 designates a sequence or sequences as requiring anticipatory processing, Selector 404 sends a signal to ResourceRequestor 410 indicating the designated event-sequence or sequences. ResourceRequestor 410 then requests that the system allocate the resources necessary to perform the desired function. This may mean signaling another entity (software or hardware) with responsibility for delegating resources. If the system can allocate the requested resources, they will then be available for performance of the desired function when the user commits to the anticipated selection, usually by releasing the mouse button.

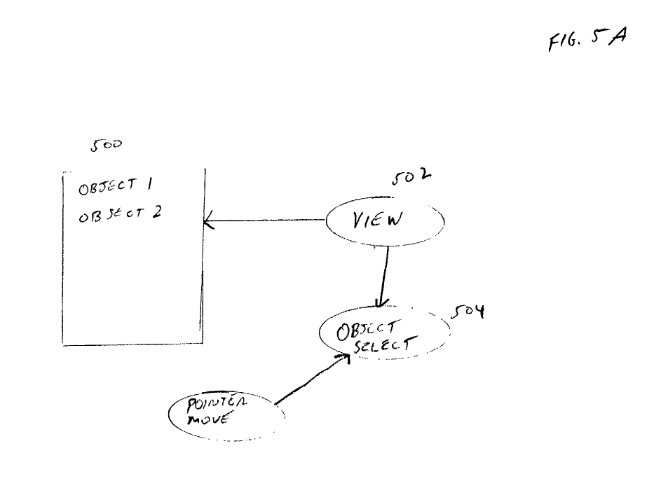

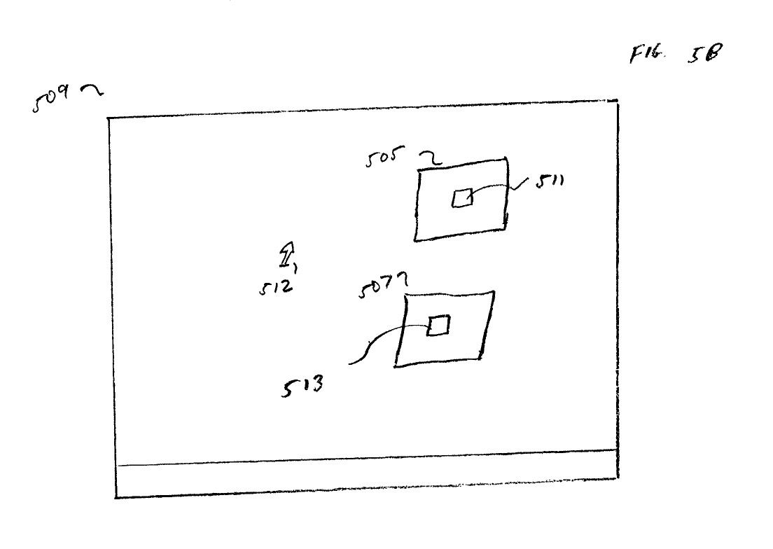

In the second embodiment, no inquiry event exists and the display merely shows various icons, representing objects. Referring to FIG. 5A, a table 500 contains a list of objects which have been predetermined to require anticipatory processing. In an initialization step, an object View 502 accesses the table 500 to determine which objects represented on the GUI display require anticipatory processing. (For ease of understanding, representations of objects on the GUI display are hereinafter referred to as objects). View 502 then monitors a predetermined area about each such object for entry of a pointer as, for example, the pointer 512 of FIG. 5B. For instance, in the display 509 of FIG. 5B, View 502 monitors predetermined areas 507 and 505 which surround objects 511 and 513.

It is an advantage of the described embodiment that the system designer or user develops and implements criteria for including objects in the table 500. Inclusion may be based upon system criteria, resource requirements, functional priority, context of prior selections or frequency of prior use. Another possible criteria is to place only those objects in the table 500 which require distributed resources. The list of objects included in table 500 may be static or it may change during the user session depending upon the implemented criteria. Yet another alternative would be to include only objects which control some system or device outside the computer system. Of course, all objects may be placed in the table 500, if so desired.

Still referring to FIG. 5A and to FIG. 5B, View 502, upon detecting the entry of the pointer 512 in a monitored area about an object, signals ObjectSelect 504. If the pointer 512 stops or slows in the area (a predetermined move event), PointerMove 506 signals ObjectSelect 504 of the event. ObjectSelect 504 initiates anticipatory processing, if it receives a signal that the pointer 512 entered an area, followed by a signal that the pointer 512 has slowed or stopped (or any other desired move event). If the pointer 512 leaves the area before a confirming event (i.e., a mouse button release), View 502 signals ObjectSelect 504 and any anticipatory processing ceases.

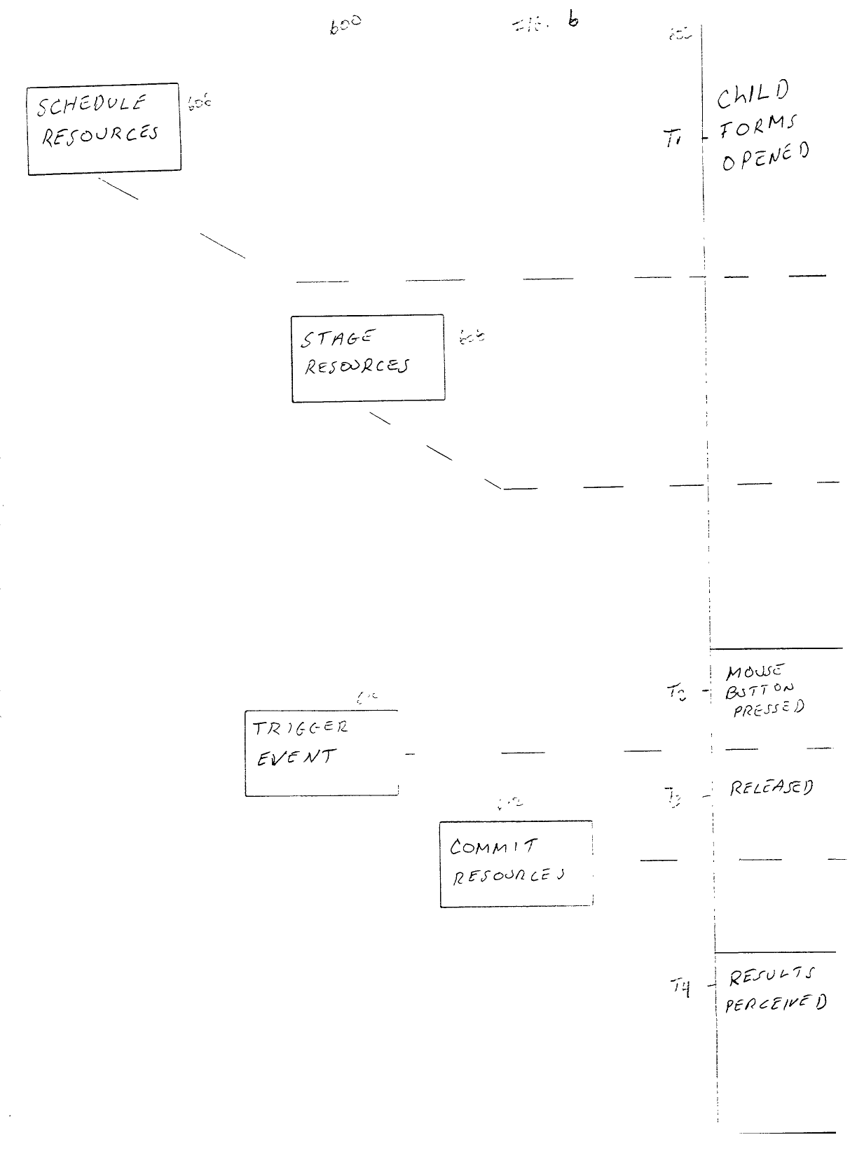

Once an object is designated for anticipatory processing, pursuant to either of the just described embodiments, the system prepares for the selection of the object, as shown in the process diagram 600 of FIG. 6. The vertical line 602 represents the user interface with the GUI as well as a time line proceeding from top to bottom. At time TI, the user perceives the opening of child forms, such as a submenu, which is an inquiry event. The cause of this inquiry event may be a response to a previous user event or an event caused by some apparatus. The method and apparatus of the invention designates an event-sequence for anticipatory processing. Once a sequence is designated, the system schedules resources 606 and stages the resources 608 necessary to perform the function. At time T2, the operator depresses a selection button, such as in a mouse, causing Trigger Event 610. This event 610 signals that the user has either selected or not selected the anticipated object. When the user selects an anticipated sequence and the selection button is released at time T3, the system commits the allocated resources 612. The user perceives the results of the selection at T4.

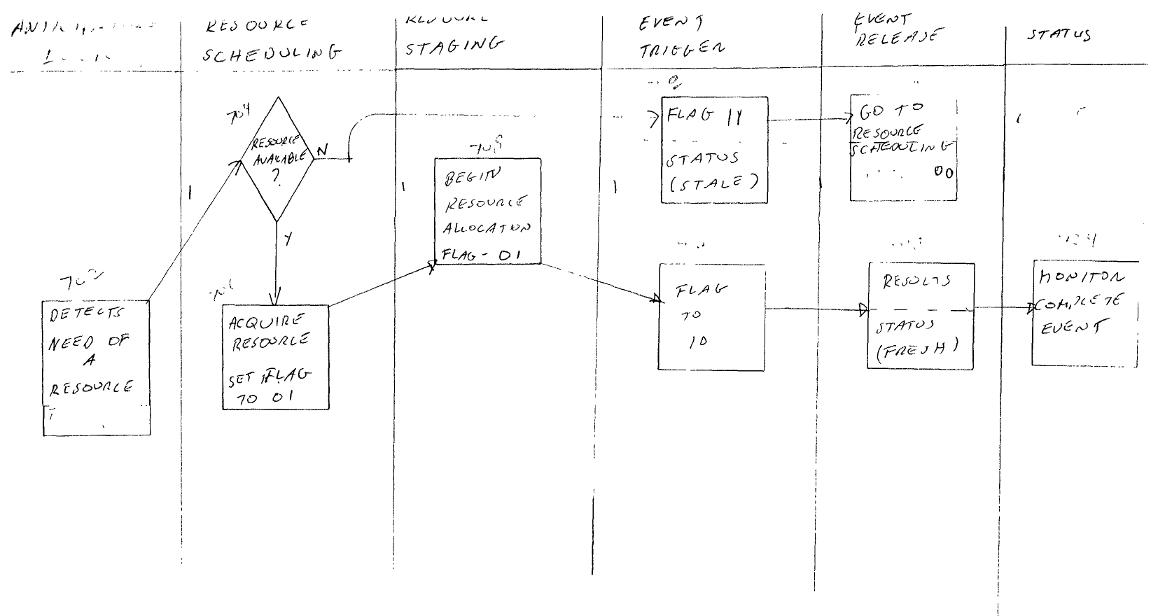

Processing according to the method of this invention is further described with reference to the diagram 700 presented in FIG. 7. Anticipatory Logic in the process step 702 implements selection of an object or event for anticipatory processing according to one of the embodiments shown in FIG. 4A or FIG. 5A. That process step 702 determines the object for selection and detects the need of a resource. During Resource Scheduling, the system determines whether the required resources are available in a decision step 704. In the illustrated embodiment, the decision is made with reference to a two bit Flag. If the Flag is 00, the resource is available.

Assuming resource availability and still during Resource Scheduling, the system acquires the resources in a process step 706. Once the resources are acquired the Flag is set to 01 and Resource Staging may begin. With the Flag set to 01, the resource is not allocated, but the anticipated function may arbitrate for the resource as if the function had been selected. In Resource Staging, the system begins allocating the resource to the desired function in a resource allocation step 708 and the Flag is still set to 01; in other words, the resources will be committed to the anticipated function when the user commits to the object with the pointing device. When the mouse selection button is depressed, causing Event Trigger, the Flag is set to 10 in a process step 714, indicating that the resource is now being used. When the button is released, causing Event Release, the results are provided to the GUI in a process step 718 and status is shown to the user, who monitors the event 724 on the display.

If in the decision step 704 the system determines that the Flag is set to 11 and that, therefore, the required resource is unavailable, no processing occurs in Resource Staging and the system awaits Event Trigger (the mouse button is depressed). When the system receives Event Trigger, the process step 712 reads the Flag which is set at 11. The status of the display is stale; in other words, no function has been performed and no results are observed. When Event Release occurs, a process step 716 determines that the resource is required, sets the Flag to 00 when the resource is available, and returns process control to the decision step 704 in Resource Scheduling. With the Flag set to 00, process continues in Resource Staging as previously described.

The invention will now be described in the context of several exemplary applications. Consider the invention used in a system for controlling a telephone system. An operator (user) using a computer displayed control panel connects calls, routes calls, investigates failed call attempts and corrects call failures. In a preferred embodiment, the control interface, i.e., the GUI, prompts the user of desired functions in the context of the system state. The interface presents the user with system data and control objects, like switches, by which the user controls the system.

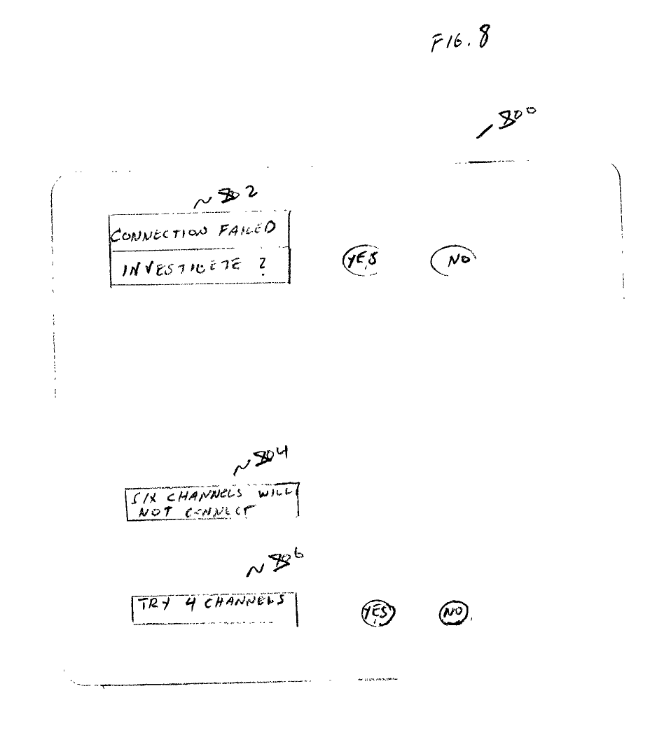

Referring to the interface display 800 shown in FIG. 8, consider that a six channel bonded call attempt fails. The system determines that the call failed because one channel refused to connect. This may be due to improper provisioning of equipment or because the network lacked the capacity required to connect the call. In any case, selecting four channels rather than six may result in a successful call. The system inquires of the user through a GUI window 802 whether the user desires the computer to investigate the call and suggest solutions. According to the method of the invention, while awaiting a decision, the system notes the inquiry event, determines the possible user responses (event-sequences), selects the sequence where the user responds YES, and requests the resources to perform the investigation and to suggest a solution.

If the user selects YES, the GUI presents the investigation results 804 and inquires whether the user wishes to implement a suggested solution 806. While awaiting the decision, the system anticipates a YES selection, pre-executes commands to the apparatus, and acquires the necessary resources to implement the solution. Once the user commits to the anticipated selection, the apparatus and resources are committed and the command is executed. For this example, such pre-execution constitutes connecting the call using four channels rather than six.

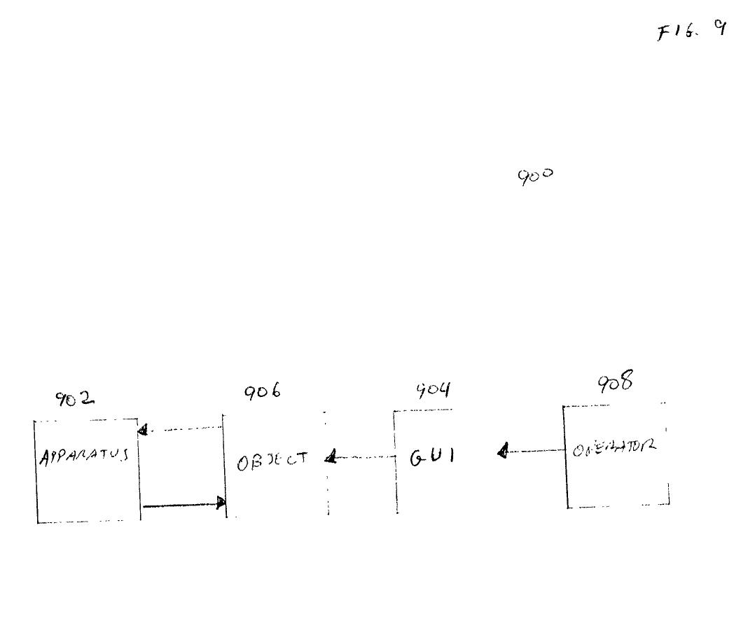

In another telephone system example, as shown in the functional diagram 900 of FIG. 9, a hardware entity 902 (apparatus) is responsible for maintaining the status of several video conferences at the same time. Each conference, of course, consists of several participants, and an operator 908 may check the list of conferences via a GUI 904. When the operator 908 wishes to access a list of participants of a particular conference, the operator 908 selects the conference by clicking a mouse manipulated pointer on a GUI 904 button. The operator 908 may also signal the apparatus 902 to present information regarding a particular participant by selecting the participant with the mouse.

A software object 906 is operable to display information from the apparatus to the operator 908 via the GUI 904. The object 906 also signals the apparatus 902 of operator 908 events, such as asking the apparatus 902 for a list of participants or information about a participant. In the method according to this invention, the apparatus 902 presents a list of participants to the operator 908 on the GUI 904 display. According to the embodiment of FIG. 4A, InquiryHandler 400 recognizes the presentation of participants as an event of interest. Selector 404, according to a predetermined selection criteria, designates some operator 908 response (selection of a participant) for anticipatory processing. In this example, all participants are so designated; in other words, processing is started for the selection of any displayed participant.

ResourceRequestor 410 asks the system to allocate the resources necessary to display information concerning all the participants listed on the GUI 904, and the system instructs the object 906 that the operator 908 requires information concerning all participants. The object 906 queries the apparatus 902 for information on all participants and the object 906 makes the information ready for display on the GUI 904 display. When the operator 908 releases the mouse button for a particular participant, the information is displayed without waiting for allocation of resources and querying of the apparatus 902.

Consider a third example where a control application controls a test stand for some unit under test. It is unimportant what the test stand tests, except that it is responsive to signals generated by a computer. In this example, the test stand monitors certain environmental conditions like temperature and pressure. On the control interface, the user is presented a switch object which tells the computer to turn on the unit under test. The user activates the switch by selecting it with a pointing device. The unit under test, however, will not power-up unless the monitored environmental conditions are within a specified range.

In a control interface according to the present invention, the switch object is placed in a lookup table as a selection requiring anticipatory processing. With reference to the embodiment of FIG. 5A, when the operator moves the pointer to the proximity of the switch object, ObjectSelect 504 is signaled by View 502 that the pointer entered the area about the switch. As the user begins to slow the pointer, PointerMove 506 signals ObjectSelect 504. ObjectSelect 504 then signals, ResourceRequestor 410 which asks the system to allocate resources necessary to power-up the unit. If the resources are available, the system begins its environmental analysis and accesses the unit under test. Once the user commits to the switch, the computer activates the unit or signals the user that environmental conditions are unacceptable.

In a final example, a user selects a mortgage calculation object and inputs requested data via a GUI. The last inquiry from the application asks the user to choose a presentation format. All choices for presentation will require resources necessary to process the mortgage calculation. While the application awaits the GUI signal to process and present data, the resources are acquired and allocated for the calculation and the presentation. The GUI signals the computer platform to process the numbers and ready the data for the selected presentation format. When the user commits to a presentation format, the calculation results are presented. The user perceives this as near instantaneous processing.

What is claimed is:

1. A method for operating a computer having a graphical user interface (GUI) and a selection device, the method comprising the steps of:
designating at least one event-sequence for anticipatory processing, an event-sequence being at least one user-generated event; and
preparing resources for the computer to execute in accordance with said at least one event-sequence.

2. The method of claim 1 wherein said step of designating at least one event-sequence for anticipatory processing comprises:
recognizing an inquiry event, said inquiry event at least one user response;
determining a set of event-sequences, comprising possible user responses to said inquiry event; and,
applying a selection criteria responsive to said set of event-sequences, wherein at least one event-sequence is designated for anticipatory processing.

3. The method of claim 1 wherein the at least one object is responsive to provide at least one inquiry event.

4. The method of claim 1 wherein said at least one event-sequence is selected from the group comprising event-sequences requiring the computer to access a controlled device, event-sequences requiring the computer to access distributed resources, event-sequences requiring the computer to access non-distributed resources, or event-sequences requiring the computer to access the most resources.

5. The method of claim 2 wherein the step of determining a set of event-sequences includes the step of associating an inquiry event with a set of event-sequences contained in a look-up table.

6. The method of claim 2 wherein the selection criteria is applied in the computer.

7. The method of claim 1 wherein said step of designating at least one event-sequence for anticipatory processing includes the steps of:
providing a look-up table having a plurality of objects, said objects being displayed on a display device; and,
monitoring a predetermined area about each said object contained in said look-up table.

8. The method of claim 7 wherein said selection device comprises a pointer, the method comprising the further steps of:
determining when said pointer enters one of said predetermined areas; and,
designating selection of said object within said predetermined area as said at least one event-sequence for anticipatory processing.

9 The method of claim 8 comprising the further step of determining when said pointer slows in any one of said predetermined areas.

10. The method of claim 1 wherein said step of preparing resources for the computer to execute according to said designated at least one event-sequence comprises the further steps of:
requesting resources for the computer to execute according to said at least one event-sequence; and,
allocating said resources for the computer to execute according to said at least one event-sequence.

11. The method of claim 1 wherein the GUI is a control interface.

12. An apparatus for performing anticipatory processing for a computer having an object on a GUI display, the GUI responsive to a selection device for selecting the object, the apparatus comprising:
selection means for designating at least one event-sequence for anticipatory processing; and,
means for preparing the computer to execute in accordance with said at least one event-sequence.

13. The apparatus of claim 12 wherein said selection means comprises:
an InquiryHandler object responsive to a non-user event to the GUI, said InquiryHandler object operable to provide a set of event-sequences; and,
a Selector object responsive to said set of event-sequences, said Selector object operable to select at least one of said event-sequences for anticipatory processing.

14. The apparatus of claim 12 wherein said means for preparing the computer to execute in accordance with said at least one event-sequence comprises:
a ResourceRequestor object responsive to said selection means, said ResourceRequestor object operable to request resources required for the computer to execute in accordance with said at least one event-sequence.

15. The apparatus of claim 13 wherein said InquiryHandler object is operable to access a look-up table, said look-up table associating an inquiry event with a set of event-sequences.

16. The apparatus of claim 13 wherein said Selector object is operable to access a look-up table, said look-up table operable to identify resources for the computer to execute in accordance with each of said event-sequences in said set of event-sequences.

17. The apparatus of claim 13 wherein said Selector object is operable to apply a predetermined selection criteria for selecting said at least one event-sequence.

18. The apparatus of claim 12 wherein said selection means comprises:
a View object operable to monitor a predetermined area about the object on the GUI display, said View object responsive to said pointer entering said predetermined area;
a PointerMove object operable to determine movement of said pointer on the GUI display, said PointerMove object signaling a move event when said pointer moves; and,
an ObjectSelect object responsive to events from said View object and from said PointerMove object, wherein said ObjectSelect object selects the object on the GUI display for anticipatory processing upon entry of the pointer into said predetermined area followed by a predetermined move event.

19. The apparatus of claim 18 wherein said View object is operable to access a look-up table, said look-up table comprising a list of predetermined objects on the GUI display.

20. The apparatus of claim 12 wherein the GUI is operable to interface a user with a computer system controlling a device.

21. Apparatus for performing anticipatory processing for an object on a GUI display, the apparatus comprising:
a selection device for selecting the object on the GUI;
a processor operable to execute according to predetermined instructions, said processor being responsive to the selection device;
a memory for storing said predetermined instructions, wherein said predetermined instructions are operable to cause said processor to designate at least one event-sequence for anticipatory processing; and,
means for preparing the computer to execute in accordance with said at least one event-sequence.

22. The apparatus of claim 21 wherein said memory is further operable to cause said processor to query an availability of a resource required for execution in accordance with said at least one event-sequence, said preparing means comprising:
a flag register, said processor operable to set said flag register to a predetermined value according to said availability of said resource, wherein said processor allocates said resource according to said predetermined value of said flag register.
